(19) United States
(12) Patent Application Publication
(10) Pub. No.: US 2012/0201739 A1
(43) Pub. Date: Aug. 9, 2012

(54) STORAGE MATERIAL

(75) Inventor: Timothy E. Kidd, Cedar Falls, IA (US)

(73) Assignee: UNIVERSITY OF NORTHERN IOWA RESEARCH FOUNDATION, CEDAR FALLS, IA (US)

(21) Appl. No.: 13/266,630

(22) PCT Filed: Apr. 30, 2010
(86) PCT No.: PCT/US2010/033081

§ 371 Date: Mar. 16, 2012

Related U.S. Application Data
(60) Provisional application No. 61/174,280, filed on Apr. 30, 2009.

(51) Int. Cl. C01B 3/02; C01G 45/00; C07C 31/08; C01B 31/18; C07C 31/04

(52) U.S. Cl. 423/418.2; 423/648.1; 568/840; 423/511

(57) ABSTRACT

A method of providing and using a material storage system that includes a material stored within an intercalated dichalcogenide material. Also provided are novel materials for use in preparing such a system, including combinations and systems thereof, as well as a material stored and recovered for use by employment of such a method.

### TECHNICAL FIELD

In one aspect, the present invention relates to methods and compositions for storing atomic and molecular materials. In another aspect, the invention relates to intercalated dichalogenide materials.

### BACKGROUND OF THE INVENTION

The storage of materials, including at the atomic and molecular level, has taken on ever increasing attention with the advent of new technologies and corresponding demands for storage, and in particular, achieving increased storage capacity at lesser overall cost.

By way of example, hydrogen fuel represents a non-polluting alternative to fossil fuels. One attraction of hydrogen is that, by weight, hydrogen has more stored energy per pound than any energy source outside of nuclear power. Among the biggest drawbacks holding back this technology, however, is the fact that in its natural state, hydrogen is a dilute gas, so that the energy per unit volume tends to be quite small. In turn, one of the biggest obstacles in having hydrogen become an economical alternative to fossil fuels is the development of high density storage media that can store hydrogen reliably, and at energy densities (in terms of weight and volume) that are on the order of existing fuels.

As an energy source, hydrogen is particularly attractive because of its versatility. It can be used as a replacement energy source to compete on many scales, from the scale of personal electronics to vehicular power to mega watt generator systems. Hydrogen energy can be used as a replacement for batteries of any size, portable or backup power generators, off-grid generators for remote or rural locations, transportation or machinery such as cars, tractors, forklifts, or trucks to name a few, and anywhere else a portable on-demand energy source is required. It could also be used to smooth out energy production in coal of nuclear power plants, where much energy is wasted at night. Regardless of scale, one of the key issues that continue to hamper the use of hydrogen as an energy source is storage density, especially by volume, given the difficulty in compressing hydrogen down to usable volumetric densities.

On a separate subject, dichalcogenide materials exist, in varying forms, and have been used or proposed for use in various applications such as lubricants, solar cells, or exotic electronic devices. See, for instance. “Layer type tungsten dichalcogenide compounds: their preparation, structure, properties and uses,” S. K. Srivastava and B. N. Avasthi (1985) Journal of Materials Science 20, p. 3801-3815.

Moreover, such dichalcogenide materials have been intercalated (also referred to as ‘doped’) with various materials, often for purposes of energy storage (e.g., using Lithium as the intercalant) although these have not found practical use. See, for instance, “Electrical Energy Storage and Intercalation Chemistry”, M. S. WHITTINGHAM (1976) Science 192 (4244), 1126. [DOI: 10.1126/science.192.4244.1126]. Dichalcogenides have also been intercalated as a step in the formation of exfoliated dichalcogenides, with large surface areas that may be useful for catalyzing or adsorbing gasses.

What is clearly needed are new methods and corresponding materials useful for storing other materials, such as hydrogen.

### SUMMARY OF THE INVENTION

Applicant has discovered, inter alia, that intercalated dichalcogenide materials can be used for the storage of various materials, such as hydrogen, in a manner that provides improved high density storage media that are equal to, if not better than, conventional storage media used for existing (e.g., hydrogen) fuels.

The present invention provides a method of providing and using a material storage system, the method comprising the steps of:

a) providing a first material comprising an intercalated dichalcogenide material, the first material having one or more original properties;

b) providing a second material comprising a material to be stored;

c) exposing the first and second materials to each other under conditions suitable to permit the second material to become stored within the first material, forming a combination product comprising the first and second materials; and

d) thereafter recovering the second material from the combination product, by exposing the combination product to suitable conditions, in such a manner that the first material substantially retains its original properties.

In another embodiment, the invention provides a system for providing such a combination product, the system comprising the second material and a first material adapted to store the second material. The system can be provided in any suitable form, e.g., as a kit, or collection of materials and corresponding equipment suitable for delivery, set up and use. In certain embodiments, the invention provides first and/or second materials that are considered novel in their own right, in a form particularly adapted for use in preparing a combination product of this invention.

In yet another embodiment, the invention provides a combination product, per se, the combination product comprising a second material stored within a first material, in a manner that permits the second material to later be recovered from the combination product.

In yet another embodiment, the invention provides a second material recovered from a combination product of this invention.

### BRIEF DESCRIPTION OF THE DRAWINGS

FIG. 1 provides a schematic depicting the layered structure of a conventional TMDC material.

FIG. 2 shows the schematic of FIG. 1, depicting also various ions and/or molecules of an intercalant between the layers of the layered structure.

FIG. 3 shows a schematic comparison of hydrogen storage into an intercalated dichalcogenide (FIG. 3A) and a pure dichalcogenide (FIG. 3B).

FIG. 4 provides data showing mass changes of the Mn_{0.125}TiS2 sample on increasing hydrogen pressure as measured in atmospheres. Absorption and desorption are performed at room temperature. Nearly all of the hydrogen is stored (or desorbed) within one minute of increasing (or decreasing) the pressure to the new level.

### DETAILED DESCRIPTION

The method of this invention comprises the steps of providing a first material comprising an intercalated (doped) dichalcogenide material. A first material of this invention is preferably in the form of an intercalated dichalcogenide material. Those skilled in the art will understand the manner in which suitable first materials can be prepared using various materials and corresponding methods. The original properties of the first material can be selected from the group consisting of the crystal structure (e.g., layer spacing) or chemical composition (e.g., intercalant content).

The first material can either be obtained in a form suitable for use (e.g., as an intercalated dichalcogenide material), or can be prepared by the intercalation of a dichalcogenide with intercalant. Those skilled in the art, given the present description, will understand the manner in which the calcogenide or dicalcogenide can be of any suitable type and form.

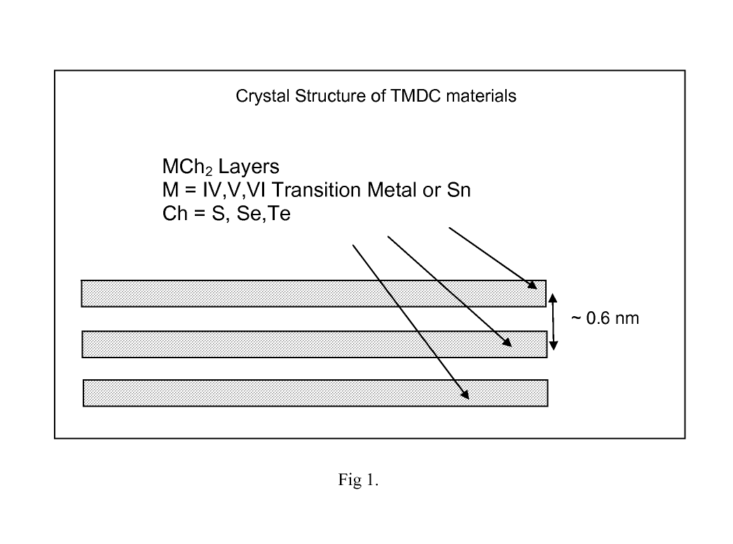

Suitable dicalchogenide materials are typically layered materials formed of MCh2 (as depicted in FIG. 1) with strongly bound 2D sheets that are themselves weakly bound together and having a CdI2 crystal structure. In FIG. 1, M can be one of Group (IV, V, or VI) transition metals, Sn or Si and perhaps some other semiconductors, and Ch is S, Se, or Te. The dichalcogenide can also be formed of a combination of metals (or other atoms) and chalcogens to form a layered structure, e.g., Tiₓ, Ta₁₋ₓ, S_{y}, and Se_{2-y}. The layers can be any suitable distance apart, e.g., between about 0.4 and about 1 nm (distance between metal ions) with some dependence on the composition of the material and presence of impurities. Prior to intercalation, such materials can be created in any suitable form, e.g., as a powder (e.g., small crystal) or in a large single crystal form (several mm diameter, sub-mm thickness), or optionally can be deposited as films onto various substrates.

The dicalchogenide can also be formed in any suitable structure or shape, e.g., as fullerene nanostructures (e.g., tubes, buckeyballs) where the flat sheets are “rolled up”. Similarly, powder or crystals can be exfoliated to separate the sheets of the material into small pieces that are approximately one molecule thick, while single layer sheets can be processed to create a house of cards type structure with a very large surface area.

Examples of suitable intercalants include, for instance, transition metals (e.g., Pt, Pd), organic molecules (e.g., hydrazine, pyridine, etc.), and rare earth, alkali metals. Such intercalants are capable of being added to a dicalchogenide, in the form of impurities that will be placed between the layers of the material. This leaves the overall structure of the material relatively unchanged except for the spacing between the layers. Then resulting structures take the form DₓMCh₂, where: D then is the dopant, which can be nearly any electron donating material (plus some others); and X is the concentration, which can range between 0 and one for most cases. By way of example, a preferred intercalated material is Mn_{0.4}TiS₂. In particularly preferred embodiments, Ch is limited to S or Se for intercalation.

Multiple intercalants can be introduced as well, e.g., as in D1_{X1}D2_{X2}MCh₂. This depends on various aspects, including in particular, the solubility for the materials within the structure. Similarly, combinations of intercalation and substitution are possible. Presently preferred intercalation includes powders and single crystals, though other forms cannot be intercalated, except for the exfoliated single molecular thickness types. There needs to be at least two sheets for there to be a place to store intercalants between them. Intercalation can be used to control and adjust layer spacing, e.g., large organic molecules can increase the layer spacing by more than a factor of 10.

In turn, a calchogenide can be used to prepare a dicalchogenide, which in turn, can be intercalated, using methods known to those skilled in the art. For instance, one common method is often referred to as the “single shot” approach in which both calchogen elements and an intercalant are obtained or prepared separately, and then mixed within a chamber (e.g., an evacuated and sealed tube) that is then heated for a period of time (e.g., on the order of hours to days), during which the ingredients (including dopants and/or intercalants) combine to form intercalated dichalcogenide materials, often in the form of powder or large crystals.

In one such “single shot” approach, the general method above is performed, though a transport agent (e.g., a halogen such as I, Cl, or Br atoms) is added in order to increase the size of the crystals and/or form fullerene structures. For instance, the tube can be is heated unevenly with one side being on the order of ˜100° C. hotter than the other.

In yet another “single shot” approach, rather than being evacuated, the tube can instead be filled with an inert gas such as argon. This can serve to alter the reaction kinetics, and in turn, to form differently sized materials and/or fullerene structures, and again, this approach can optionally include the use of iodine or another transport agent.

By comparison, a “two step” approach can also be used for preparing the first material, e.g., in which powders of the pure MCh2 structure are formed in a first step, which is then provided within a sealed chamber with the intercalant, together with either inert gas or vacuum, and optionally again, transport agent). The sealed tube containing these ingredients can be heated together to form an intercalated material. This approach can tend to improve the solubility of the eventual first material, since it tends to limit chemical reactions that might otherwise occur between the intercalant and chalcogen elements.

The first material can be prepared in a variety of other ways as well, e.g., intercalation can also be carried out electrochemically in solution using a pure MCh₂ starting powder as electrode and intercalant material either dissolved in solution or as counter electrode. Similarly, intercalation can be induced by placing MCh₂ material into a vacuum (or inert gas bearing) vessel and then introducing the intercalant in gaseous form.

The MCh₂ materials can be formed by heating the metal M in the presence of H₂S or H₂Se, then intercalated later by one of the previously mentioned processes. This process is less pure, although perhaps more economical, forming MCh₂ materials in quantity.

In a similar manner, films can be grown by evaporating, sputtering, or chemically depositing (sol gel or other techniques) either MCH₂ materials or the elemental components (M+Ch₂) usually followed by a suitable heating process to ensure smooth stoichiometric films.

Powders or crystals that have been formed of intercalated materials can be mechanically processed, e.g., via ball milling, and typically in an inert environment, in order to induce porosity and other defects in the structure. Preferably, this is done in a manner that does not unduly alter the intercalation concentration or create significant numbers of single molecule thick sheets, but may improve hydrogen storage as it gives more pathways for the hydrogen to get locked into the material.

The manner and extent of intercalation can be determined using physical and/or chemical analyses known to those skilled in the art. For instance, the chemical composition can be evaluated in order to confirm that the composition does not change when upper layers are peeled from the material. This indicates that the intercalants are stored homogenously (at least at 1 micron scale) within the material. Similarly, techniques such as scanning electron microscopy (SEM) and energy dispersive X-ray (EDX) analyses can be used to assess the manner and extent of either intercalation or storage, or both.

The resulting matricies suitable for use as a first material in a method of this invention preferably provide an optimal combination of properties such as weight, size, and surface area. Those skilled in the art will appreciate the manner in which those properties can be altered depending on the second material to be stored. For the storage of hydrogen, for instance, one would generally prefer to use dichalcogenides having lesser density, thereby likely providing larger gaps between the layers.

The first material of this invention can also be provided in any suitable form, e.g., nanotubes, thin films, fullerene structures, and other such forms. The particular form can, again, correspond to the intended use. For instance, thin films may be preferable for use with micro- or nano-scale energy sources for small scale electronics. The same or other forms might be better adapted for use in the course of trapping and storing hydrogen or other gasses produced as waste products. Nanotubes or other fullerenes tend to provide additional surface area that could enhance the absorption of hydrogen within the material.

The dopant itself can be positioned, e.g., free or bound, within the structure of the first material in any suitable manner. For instance, without intending to be bound by theory, it appears that either there is weak bonding between dopant and H₂ or that ions catalyze H₂ to 2H+. It would appear that intercalants that are positioned inside the material dramatically increase hydrogen storage; as an example, there is nearly no storage for pure TiS₂, but 3-4 H atoms stored per Mn ion in intercalated material.

The method of the present invention comprises an additional step of providing a second material comprising a material to be stored. While the second material can optionally be, or include, the same material used as the intercalant to form the first material, it is preferably a different material. The second material can be provided in any suitable form that permits it to be exposed to, and in turn, stored in the first material under the conditions of use.

In a preferred embodiment, the method comprises exposing the first and second materials to each other under conditions suitable to permit the second material to become stored within the first material, and storing the resultant combination product. The first and second materials can be exposed to each other in any suitable manner, e.g., by adding the first material to a container having the second, or adding the second to a container having the first, or bringing both together simultaneously.

Generally, the first and second materials are brought together in a manner suitable to permit increased pressure (i.e., over ambient) to be applied, in order to improve the rate and/or extent of storage. For instance, the combination product can be provided within a vessel (e.g., stainless steel vessel), that is then evacuated and, optionally, heated to desorb any absorbed gasses. In turn, the material to be stored, e.g., H₂ gas, can be introduced at various pressures. Mass changes are measured while pressure held constant. Full uptake for 100 mg sample occurred within minutes of exposure.

The second material of this invention can be of any suitable type, e.g., atomic or molecular, and in any suitable form (e.g., gas or liquid) that permits it to be exposed to the first material in a manner that permits the second material to be taken up by, and thereby stored with, the first material. The second material can be selected from the group consisting of a gas, liquid, solution, or suspension.

Examples of suitable materials for storage in the method of this invention include, for instance, hydrogen and other gasses (e.g., NH₄, CO, and hydrocarbons such as methanol, and ethanol).

Those skilled in the art will appreciate the manner in which the second material can be exposed to the first material under conditions (e.g., rate, total time, temperature and pressure) that can be selected in order to provide desired. The suitable conditions will often depend, for instance, on the makeup of both the first and second materials. Generally, the use of higher pressure will permit higher storage, toward the saturation limit.

The storage capacity of a first material of this invention can depend, for instance, on such factors as the dichalcogenide and intercalant types and intercalant concentration. Preferably, the second material is stored to saturation in the first material, which preferably, can occur within minutes, if not seconds following exposure of the two.

The resulting combination of second material stored within first material is preferably stable for storage, transportation, and later use, by recovering the second material from the first. Examples of suitable storage mechanism include, for instance, high pressure vessels having a valve that can be opened under suitable conditions to allow the second material to be released and either transported and/or used. A preferred material acts in a manner analogous to a sponge to increase storage capacity for high pressure vessel. The method and corresponding system of this invention provides for storage in a manner that is reversible, with the stored material being chemically inert and stable to the extent desired.

In such a preferred embodiment, the method comprises later recovering the second product from the combination product, by exposing the combination product to suitable conditions. In another embodiment, the invention provides a combination comprising a first material adapted to store the second material, and the second materials. In yet another embodiment, the invention provides a combination product, per se, the combination product comprising second material stored within a first material, in a manner that permits the second material to later be recovered from the combination product. In yet another embodiment, the invention provides a second material derived from a combination product of this invention.

The invention will be further described with reference to the Drawing, in which FIG. 1 shows a schematic for layered structure. Individual layers are composed of hexagonally arranged molecules of MCh₂, where M is a metal ion (from list) and Ch is S, Se, or Te. The molecules are chemically bound to each other within each layer. The attraction between layers is relatively weak and characterized by van der Waals forces.

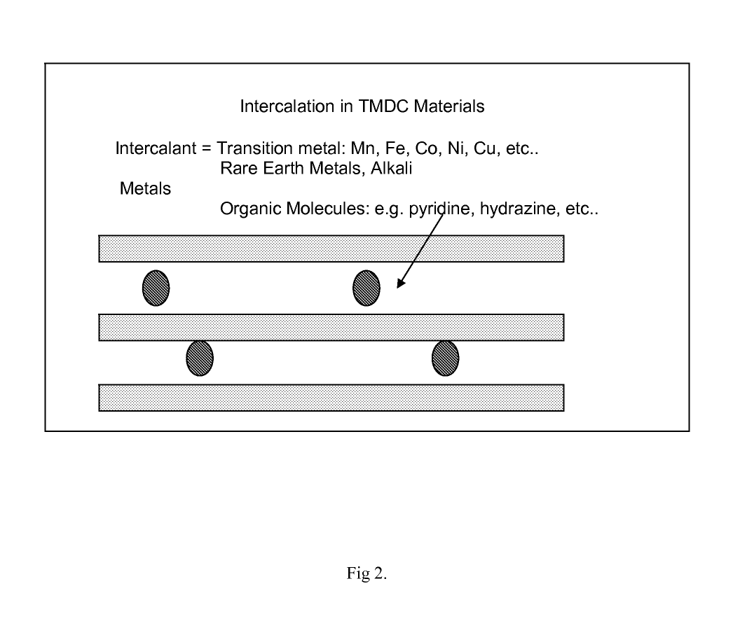

FIG. 2 provides a schematic showing intercalation of various ions and/or molecules (red ovals) is defined by storing the various ions in locations between the MCh₂ layers. Compared to other forms of doping, the purposeful introduction of impurities, this has relatively little impact on the overall structure of the layered dichalcogenide outside of altering the spacing between layers.

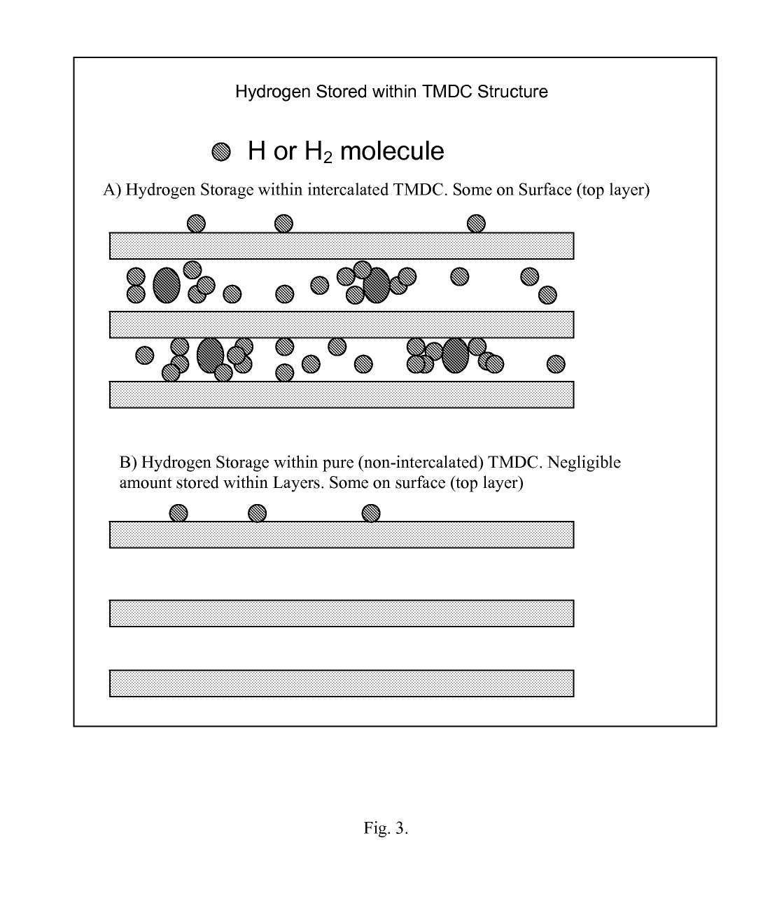

FIG. 3 provides a schematic of increased hydrogen (green circles) absorption due to intercalated ions. Our results for Mn intercalated within the TiS₂ layered dichalcogenide show that almost no hydrogen is stored within the pure TiS₂ material, and the amount of hydrogen absorbed increases with the amount of Mn intercalated within the TiS₂ system.

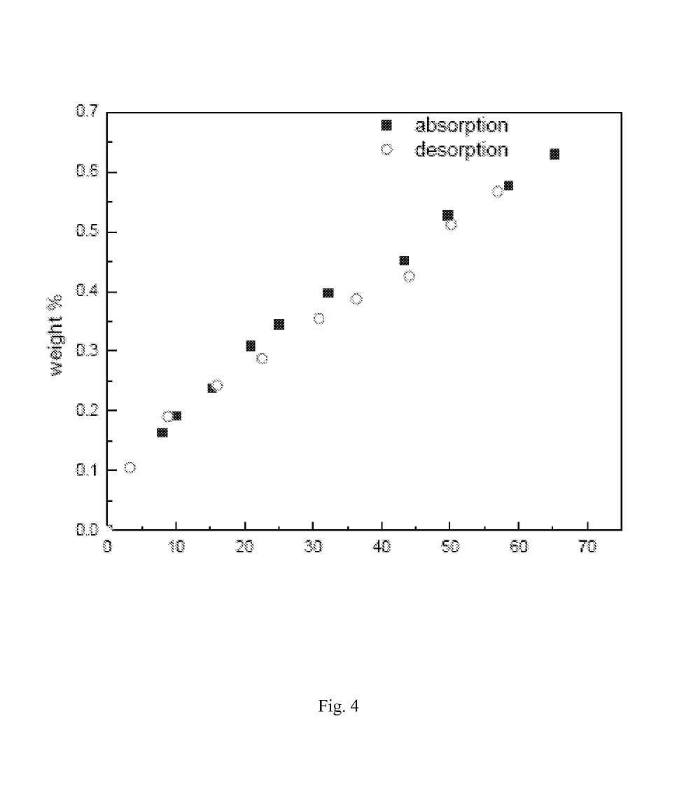

FIG. 4 shows measurements of hydrogen stored within Mn intercalated TiS₂ of the chemical form Mn_{0.125}TiS₂. The measurements were taken by measuring the weight of the material at different hydrogen pressures. The compound was initially prepared by heating in a vacuum environment to remove any impurities in anticipation of the hydrogen storage measurements. The measurements show that hydrogen is stored preferentially at higher pressures, with no saturation seen at 65 bar (65 atmospheres, 942 psi) so that more hydrogen is very likely to be stored at even higher pressures. The hydrogen stored in this material is equal to 0.65% of the total mass of the Mn_{0.125}TiS₂ compound at 65 bar and the storage is completely reversible even at room temperature. For comparison, <0.5% hydrogen was stored in pure TiS₂ and 1.5% was stored in Mn_{0.05}TiS₂ compounds in measurements taken under identical conditions. The mass changes occurred very quickly upon raising the hydrogen pressure, indicating that >90% of the hydrogen was stored within the material within less than one minute of the pressure increase.

Combined scanning electron microscope and energy dispersive x-ray spectroscopy measurements showed that the Mn intercalated samples had the chemical composition as described above. Mn ions were identified as intercalants stored within the layers, as opposed to any other possible type of dopant or inclusion, from x-ray diffraction measurements which showed the expected expansion of the layer spacing from Mn intercalation.

The results indicate there being ˜5 H atoms per Mn intercalant, demonstrating fairly linear behavior, indicating controlled storage. It would appear that hydrogen is likely to be present within the material, since surface molecules of TiS₂ represent but a small fraction (perhaps <1%) of those present. In turn, it would follow that surface absorption would require hundreds or thousands of H atoms to be bound at a single surface molecule. Though itself not an optimal sample, these results demonstrate on the order of 4× improvement over the storage capacity of a standard high pressure vessel.

Those skilled in the art will appreciate the manner in which the present invention provides methods of preparing, and using a material (e.g., gas) storage system. For instance, upon formation of a combination of the first and second materials described herein, the resulting combination can be added to a suitable container, e.g., placed within a high pressure storage tank, having suitable connections, filters, and other components.

Such storage systems, and corresponding combination products can be used, for instance for the manufacture of portable electronics, or vehicular fuel cells (e.g., modular high P storage containers). Though the mass density of a combination product may not be not high enough to meet small car goals set by DOE, it may well be able to meet needs for industrial equipment with shorter “mileage” needs like forklifts or large equipment (buses, farm machinery, construction equipment) in which mass is not as important.

What is claimed is:

1. A method of providing and using a material storage system, the method comprising the steps of:
a) providing a first material comprising an intercalated dichalcogenide material, the first material having one or more original properties;
b) providing a second material comprising a material to be stored;
c) exposing the first and second materials to each other under conditions suitable to permit the second material to become stored within the first material, forming a combination product comprising the first and second materials; and
d) thereafter recovering the second material from the combination product, by exposing the combination product to suitable conditions, in such a manner that the first material substantially retains its original properties.

2. A method according to claim 1, wherein the first material comprises an intercalated MCh2 as described herein.

3. A method according to claim 1 wherein the second material is selected from the group consisting of a gas, liquid, solution, or suspension.

4. A material storage system, comprising a combination product that comprises a first material comprising an intercalated dichalcogenide material, and a second material stored within the first material.

5. A material storage system prepared according to the method of claim 1.

6. A storage container comprising a material storage system according to claim 4.
